(19) United States
(12) Patent Application Publication
(10) Pub. No.: US 2009/0120749 A1
(43) Pub. Date: May 14, 2009

(54) Vibration damper and method for the production of a three-pipe system for a vibration damper

(75) Inventor: Berthold Kolz, Gusenburg (DE)

Correspondence Address: COLLARD & ROE, P.C., 1077 NORTHERN BOULEVARD, ROSLYN, NY, 11576, US

(73) Assignee: ThyssenKrupp Bilstein Suspension GmbH

(21) Appl. No.: 12/283,884

(22) Filed: Sep. 16, 2008

(30) Foreign Application Priority Data
Nov. 14, 2007 (DE) 10 2007 054 275.7

(51) Int. Cl. F16F 9/00

(52) U.S. Cl. 188/322.19; 267/217

(57) ABSTRACT

A hydraulic vibration damper has an inner pipe, a center pipe, and an outer pipe. A piston on a piston rod is guided to be displaceable in a working space that is formed by the inner pipe. Flow spaces that are hydraulically separated from one another and connected with a valve module are formed between inner pipe and center pipe. The center pipe has a radially projecting formed-out part, at which the center pipe is connected with the outer pipe or the inner pipe, via a press fit. The passage openings of the center pipe and of the outer pipe are disposed in the region of the formed-out part. Also, a separation system for hydraulic separation of the flow spaces is situated in the region of the formed-out part. Also provided is a method for the production of a three-pipe system for a vibration damper.

### CROSS REFERENCE TO RELATED APPLICATIONS

Applicants claim priority under 35 U.S.C. 119 of German Application No. 10 2007 054 275.7 filed Nov. 14, 2007.

### BACKGROUND OF THE INVENTION

1. Field of the Invention

The present invention relates to a hydraulic vibration damper, particularly for motor vehicles, having an inner pipe, an outer pipe that surrounds the inner pipe, and a center pipe that is disposed between inner pipe and outer pipe. The inner pipe encloses a working space that is filled with hydraulic fluid, which space is divided into two chambers by a piston that is disposed on a piston rod and guided to be displaced in the working space. A flow space on the piston rod side and a flow space away from the piston rod are formed between the inner pipe and the center pipe, which spaces are hydraulically separated from one another and connected with a valve module disposed on the outer pipe, by way of a passage opening in the center pipe and a passage opening in the outer pipe, in each instance.

Typically, the flow space on the piston rod side is connected with the related chamber on the piston rod side, and the flow space away from the piston rod is connected with the related chamber away from the piston rod, so that when the piston moves, the hydraulic fluid can flow through openings or valves of the piston, on the one hand, and, on the other hand, in parallel, through the flow spaces and the valve module, from one chamber into the other, for pressure equalization. The valve module serves to change the damping characteristics and can preferably be actively controlled by means of a regulation device, thereby making it possible to improve the driving behavior and driving comfort of a motor vehicle. Usually, the vibration damper has a bottom valve at the end of the chamber away from the piston rod, whereby the bottom valve of the chamber away from the piston rod is connected with an equalization space, which has compressed gas applied to it. In this connection, the equalization space can be configured between center pipe and outer pipe, in practical manner.

2. The Prior Art

A vibration damper having the characteristics described initially is known from the reference DE 196 52 819 A1. A center pipe is attached to the inner pipe, at its ends, in clamped manner, whereby the inner pipe and the outer pipe are connected with one another at their ends. The flow spaces formed between inner pipe and center pipe are hydraulically separated from one another. These flow spaces are connected with the related chamber of the working space by way of a bore, in each instance. A part of the hydraulic fluid flows through the flow spaces and the valve module during a stroke movement. The valve module is connected by way of a connection plate, whereby the center pipe and the outer pipe each have a large opening, into which the connection plate with connection lines is set. The assembly of the valve module is complicated. On the one hand, a plurality of individual parts have to be arranged, and on the other hand, the different parts must be sealed relative to one another in complicated manner. The complicated assembly can also lead to increased scrap during production, and to a greater tendency of the finished vibration damper to wear out.

Another vibration damper of this type is known from the reference EP 0 905 408 A2, whereby the center pipe is disposed on the inner pipe, in clamped manner, and whereby inner and outer pipe are connected with one another at their ends. For the connection with the valve module, the center pipe has passage openings having a collar that runs around the opening, in each instance. The passage openings of the center pipe align with related passage openings of the outer pipe, in each, instance, whereby a gap remains between the collars that project from the center pipe and the outer pipe as the result of the assembly process. The valve module is set into the collars with sleeves. A seal is required, on the one hand, between valve module and outer pipe, and, on the other hand, between valve module and center pipe.

### SUMMARY OF THE INVENTION

Against this background, it is an object of the invention to provide a vibration damper having a three-pipe system, which damper is easy to produce.

These and other objects are achieved, according to the invention, starting from a vibration damper having the characteristics described initially, by providing the center pipe with a radially projecting formed-out part, at which the center pipe is connected with the outer pipe or the inner pipe, in hydraulically sealed manner, by means of a press fit, and by disposing the passage openings in the region of the formed-out parts. A separation system for hydraulic separation between center pipe and inner pipe, or between center pipe and outer pipe, is set into the formed-out part between the flow spaces. According to the invention, the three-pipe system having inner, outer, and center pipe and the hydraulically separated flow spaces is produced in particularly simple manner from a few parts. The arrangement of the valve module on the three-pipe system is also greatly simplified, in this connection, because a complicated multiple seal in the region of the passage openings is not required. By simplifying the assembly and reducing the required components, the production costs are clearly reduced. Furthermore, the configuration according to the invention can also contribute to reducing scrap during production of the vibration damper, to a particular degree, and also increase the useful lifetime of the vibration damper.

The separation system is intended to have a sufficient sealing effect, on a long-term basis, on the one hand, and, on the other hand, be easy to assemble. In this connection, it is practical if the separation system has at least one elastic ring-shaped element. The separation system can have a seal ring, preferably an O-ring, disposed between two disks, under tension, whereby the disks are held on the center pipe or the inner pipe by means of a snap ring that is laid into a related groove, in each instance. In an alternative preferred embodiment, the separation system has a ring-shaped carrier, preferably consisting of plastic or sintered metal. On the inside and outside of the ring-shaped carrier, a seal ring is inserted, in each instance. The ring-shaped carrier is held on the center pipe or the inner pipe with a snap ring. In this connection, both the ring-shaped carrier and the center pipe or inner pipe, respectively, have a groove for accommodating the snap ring, in each instance. The separation systems described have a simple structure and are also particularly easy to install, because they are fixed in place with snap rings. In this connection, the seals, which are preferably configured as O-rings, are under tension in the installed state, and guarantee a permanent, reliable seal of the two flow spaces.

The further configuration of the hydraulic vibration damper according to the invention is not restricted. Typically, however, the vibration damper is configured as a two-chamber vibration damper, whereby a bottom valve is disposed at the end of the chamber of the working space away from the piston rod, which valve connects the chamber away from the piston rod with an equalization space formed between center pipe and outer pipe, which space has a compressed gas applied to it, in known manner.

The flow spaces that are hydraulically separated by the separation system in the region of the formed-out part are typically hydraulically connected with the related chamber on the piston rod side or the chamber away from the piston rod, respectively, of the working space, for example by means of a bore. To seal the flow spaces off at the end sections of the center pipe, an O-ring is preferably laid into a groove of the center pipe there, in each instance, whereby the center pipe is connected with the inner pipe, in clamped manner, by way of the O-ring.

In another aspect, the invention provides a method for the production of a three-pipe system for a vibration damper having a center pipe disposed between a first pipe and a second pipe. According to the method according to the invention, a first end section and a second end section of the center pipe are subjected to a change in radius by means of material deformation, in each instance. Subsequently, a second end section of the center pipe is subjected to a change in radius by means of material deformation. Before the deformation of the second end section, a ring-shaped separation system having at least one elastic element is disposed on a center section of the center pipe, between the first end section and the second end section, in such a manner that after the deformation of the two end sections, the center pipe and the separation system are connected with one another so as not to come loose. On the one hand, the center pipe is connected with the first pipe by way of the separation system, in hydraulically sealed and clamped manner. On the other hand, the center pipe is connected with the second pipe by way of the center section, by means of a press fit, in hydraulically sealed manner.

The center pipe can be connected first with the first pipe or with the second pipe, after deformation of the end sections, without any restriction. Furthermore, the connection with the first pipe and the second pipe can also take place in one work step. It is also possible that first, the separation system is disposed on the center section and the center pipe is connected with the first pipe, before the end sections of the center pipe are subjected to deformation, and the center pipe is connected with the second pipe by means of a press fit, in hydraulically sealed manner.

Passage openings can be made in the second pipe and in the center section, whereby after the center pipe is connected with the second pipe, the passage openings of the center pipe align with the passage openings of the second pipe. The passage openings can be produced as bores, either before the pipes are connected or separately in the center pipe and in the second pipe. They can also be produced at the same time, after the pipes have been joined together.

When using a separation system having a seal ring and two disks, it is practical if the disks are fixed in place on the center pipe or the first pipe, one after the other, under the tension of the seal ring disposed between them, by means of snap rings that engage into related grooves. Alternatively, the separation system can also have a ring-shaped carrier on the inside and outside of which a seal ring is laid in, in each instance. The carrier is then fixed in place on the center pipe or the first pipe with a snap ring that engages into a related groove. In order to be able to install the snap rings easily even in the case of an arrangement that does not allow easy access, these snap rings are preferably inserted into the related snap ring groove of the center pipe and of the second pipe, respectively, using an insertion tool.

In a first embodiment of the invention, the end sections of the center pipe are constricted by means of the material deformation, in each instance, whereby a center section that projects radially from the end sections is formed in this way. Before the second end section is constricted, the separation system must be pushed into the center pipe and disposed in the region of the center section. In this connection, the outside diameter of the separation system approximately corresponds to the inside diameter of the center pipe before the material deformation. After the second end section has also been constricted, the separation system is disposed in the region of the center section, so that it cannot come loose. Subsequently, the radially projecting center section is pressed into the second pipe, which forms an outer pipe of the three-pipe system, preferably with a press dimension of 0.2 mm to 0.3 mm, in hydraulically sealed manner. Furthermore, the first pipe, which forms an inner pipe of the three-pipe system, is pushed into the center pipe, so that flow spaces are formed between the inner pipe and the center pipe, which spaces are hydraulically separated by the separation system.

In accordance with a second embodiment of the invention, the end sections of the center pipe are radially widened by means of the material deformation, in each instance. The separation system is pushed onto the center pipe and disposed in the center section at least before the material deformation of the second end section. In this connection, the inside diameter of the separation system approximately corresponds to the outside diameter of the center pipe before the material deformation. After both end sections have been radially widened by means of the material deformation, the separation system is disposed on the center pipe so that it cannot come loose. Subsequently, the second pipe, which forms an inner pipe of the three-pipe system, is pressed into the center section of the center pipe, which section springs back in the radial direction, preferably with a press fit of 0.2 mm to 0.3 mm, in hydraulically sealed manner. The first pipe, as the outer pipe of the three-pipe system, is pushed onto the center pipe in such a manner that two flow spaces are formed between the outer pipe and the center pipe, which spaces are hydraulically separated by the separation system.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1 is a sectional representation of a vibration damper according to the invention;

FIGS. 2a and 2b are detail views in the region of a separation system of alternative embodiments of the vibration damper according to FIG. 1; and

FIGS. 3a and 3b show methods for the production of a three-pipe system for a vibration damper.

### DETAILED DESCRIPTION OF PREFERRED EMBODIMENTS

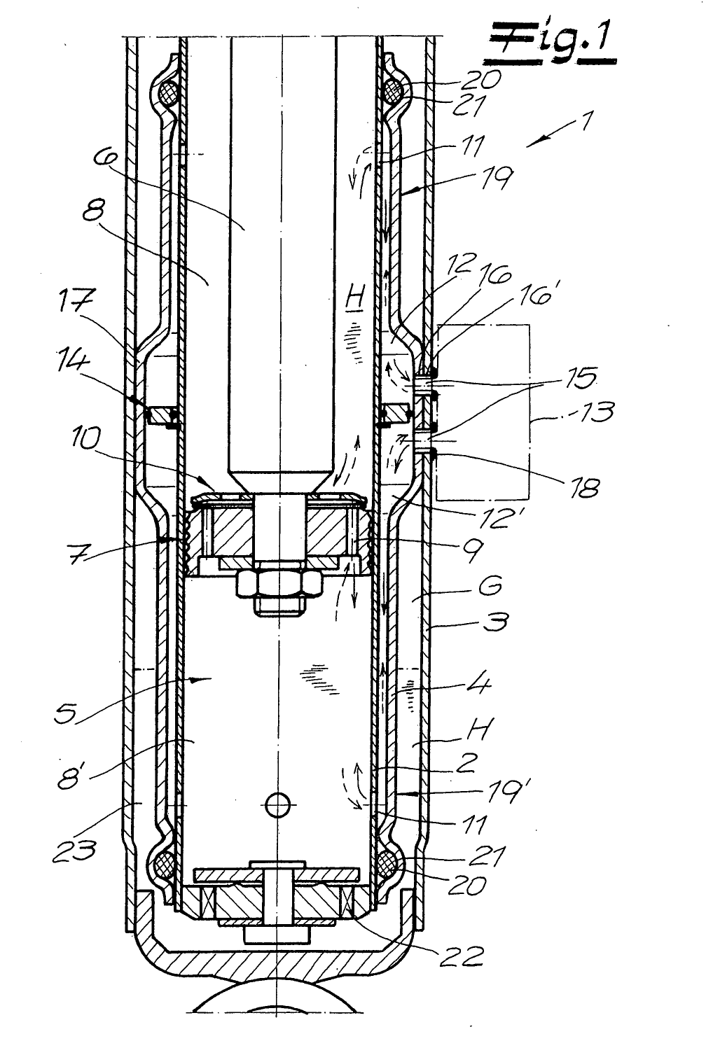

Referring now in detail to the drawings, FIG. 1 shows a vibration damper 1, particularly for motor vehicles. Vibration damper 1 has an inner pipe 2, an outer pipe 3 that surrounds inner pipe 2, and a center pipe 4 that is disposed between inner pipe 2 and outer pipe 3. Inner pipe 2 encloses a working space 5 that is filled with hydraulic fluid H. A piston 7 is disposed on a piston rod 6, guided in displaceable manner, which piston divides the working space 5 into a chamber 8 on the piston rod side and a chamber 8′ away from the piston rod.

The piston rod 6 is passed out, in usual manner, through a sealing and guidance element, not shown, at the upper end of inner pipe 2, to be connected to the chassis structure. In usual manner, passage channels 9 and valve elements 10 are disposed in the piston 7.

When movement of the piston rod 6 occurs, hydraulic fluid H can flow from one of chambers 8, 8′ into the other, through passage channels 9 and valve elements 10 of piston 7, to balance out the pressure difference that has occurred, on the one hand. Furthermore, hydraulic fluid H can also flow from one of chambers 8, 8′ into the other through bores 11 in inner pipe 2, by way of a flow space 12 on the piston rod side, a flow space 12′ away from the piston rod, and a valve module 13.

The flow spaces 12,12′ are formed between inner pipe 2 and center pipe 4, in each instance, and hydraulically separated from one another by means of a separation system 14. Valve module 13 is connected with the passage openings 16 of center pipe 4 and passage openings 16′ of outer pipe 3 with connector pieces 15, whereby a connector piece 15 is disposed, in each instance, at the related passage opening 16 of center pipe 4 and the related passage opening 16′ of outer pipe 3, in the region of a radially projecting formed-out part 17 of center pipe 4.

Because center pipe 4 is connected with outer pipe 3 in hydraulically sealed manner in the region of passage openings 16, 16′, by means of a press fit, a particularly simple arrangement of connector pieces 15 is possible. Thus, connector pieces 15 can be held in openings 16, 16′ by means of a screw connection, for example, and sealed with regard to outer pipe 3 with a single seal 18, in each instance.

At the end sections 19, 19′ off center pipe 4, flow spaces 12, 12′ are sealed off by means of O-rings 20, whereby O-rings 20 are disposed between inner pipe 2 and center pipe 4, and laid into a groove 21 of center pipe 4. A bottom valve 22 is disposed at the end of inner pipe 2 away from the piston rod, by way of which valve the chamber 8′ away from the piston rod is connected with an equalization space 23 for the hydraulic fluid H, which space is formed between center pipe 4 and outer pipe 3. In this connection, equalization space 23 has a compressed gas G applied to it. When piston rod 6 is pulled out (pulling stage), the pressure in chamber 8 on the piston rod side is increased, and the pressure in chamber 8′ away from the piston rod is decreased. In this connection, hydraulic fluid H flows along the solid-line arrows, for pressure equalization, on the one hand through piston 7, and in parallel, through flow spaces 12, 12′ and valve module 13. The damping behavior can be adjusted by control or regulation of valve module 13. In the case of pressure on piston rod 6 (pressure stage), hydraulic fluid H flows along the broken-line arrows, in the opposite direction.

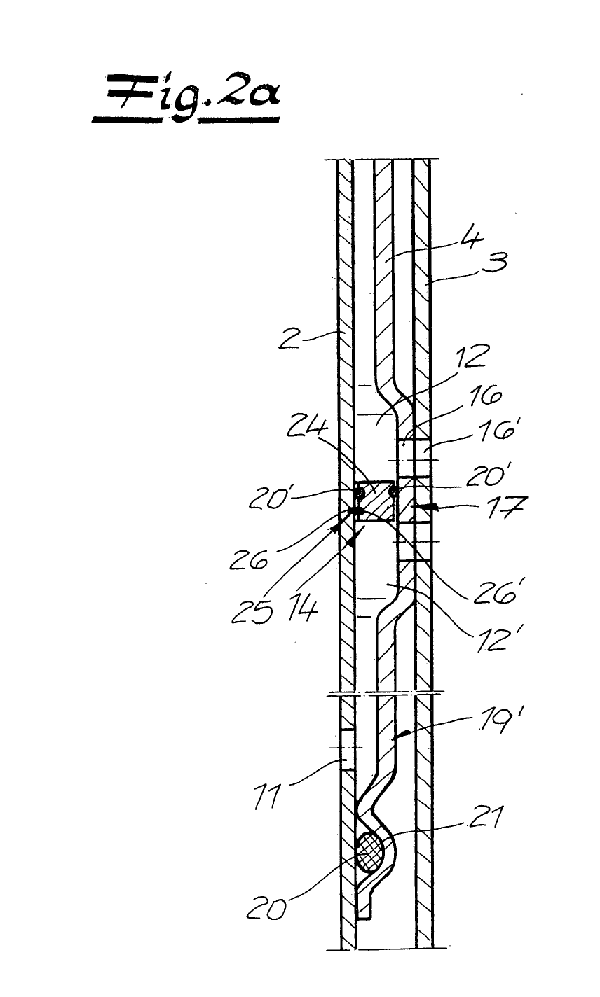

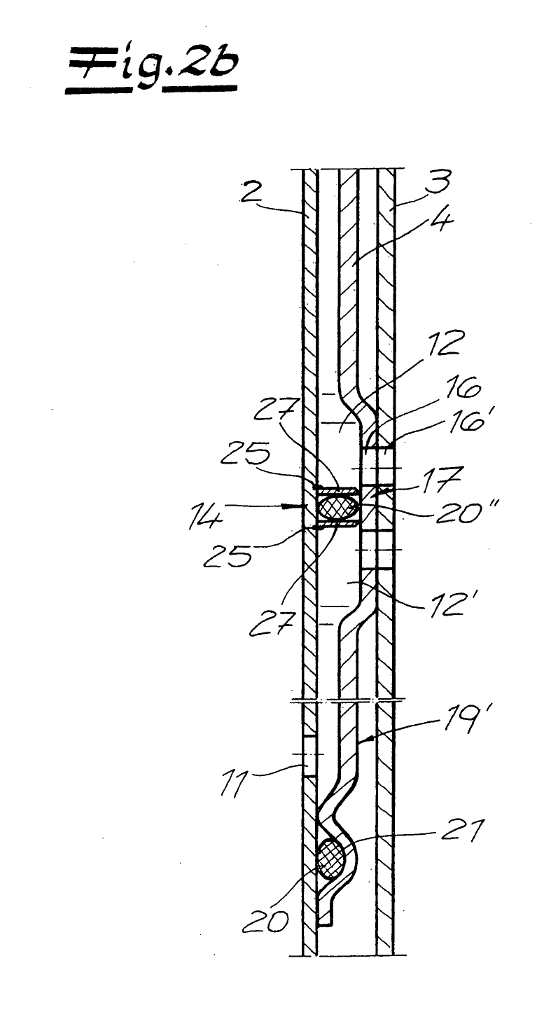

FIG. 2a shows a detail view of vibration damper 1 in the region of radially projecting formed-out part 17. The separation system 14 that is shown has a ring-shaped carrier 24, on the inside and outside of which an O-ring 20′ is laid in as a seal ring, in each instance. Ring-shaped carrier 24, which preferably consists of plastic or sintered metal, is fixed in place on inner pipe 2 with a snap ring 25. In this connection, snap ring 25 engages into a snap ring groove 26′ of carrier 24, and a snap ring groove 26 on inner pipe 2. Alternatively, ring-shaped carrier 24 can also be fixed in place on center pipe 4 by means of a snap ring 25.

FIG. 2b shows an alternative embodiment of the separation system 14, whereby the separation system has a seal ring that is disposed between two disks 27, under tension. The seal ring is preferably configured as an O-ring 20″. Disks 27 are held on center pipe 4 or inner pipe 2 by means of a snap ring 25, in each instance.

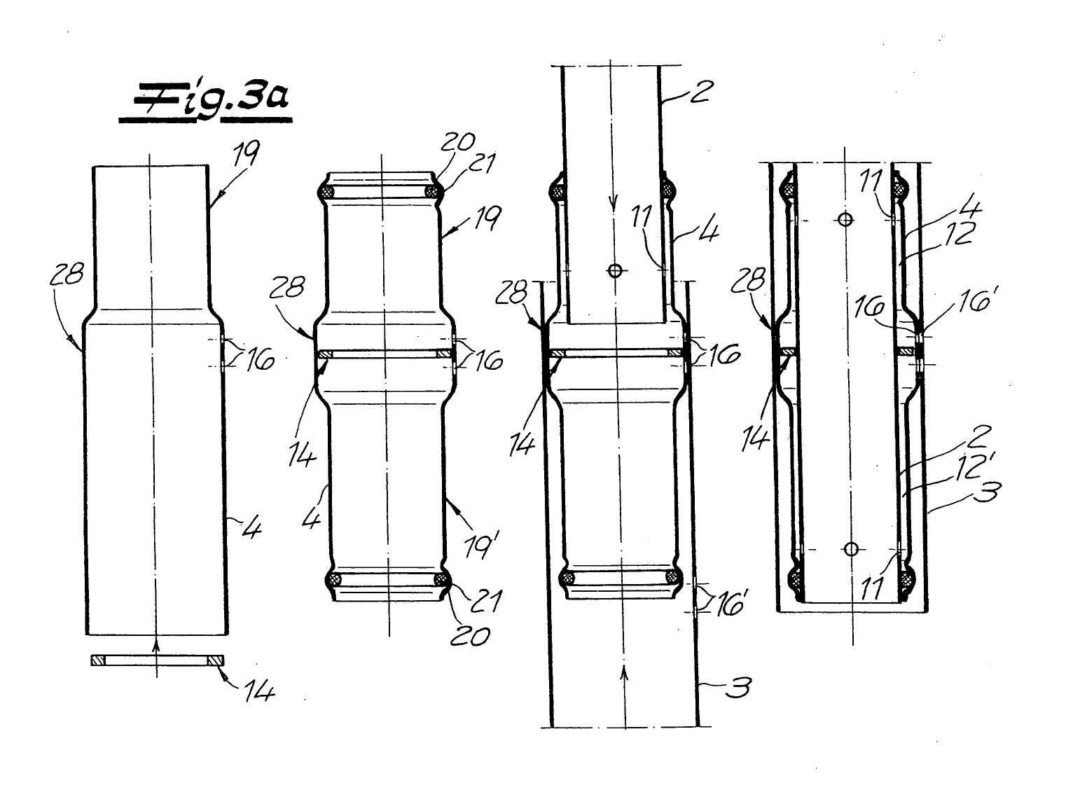

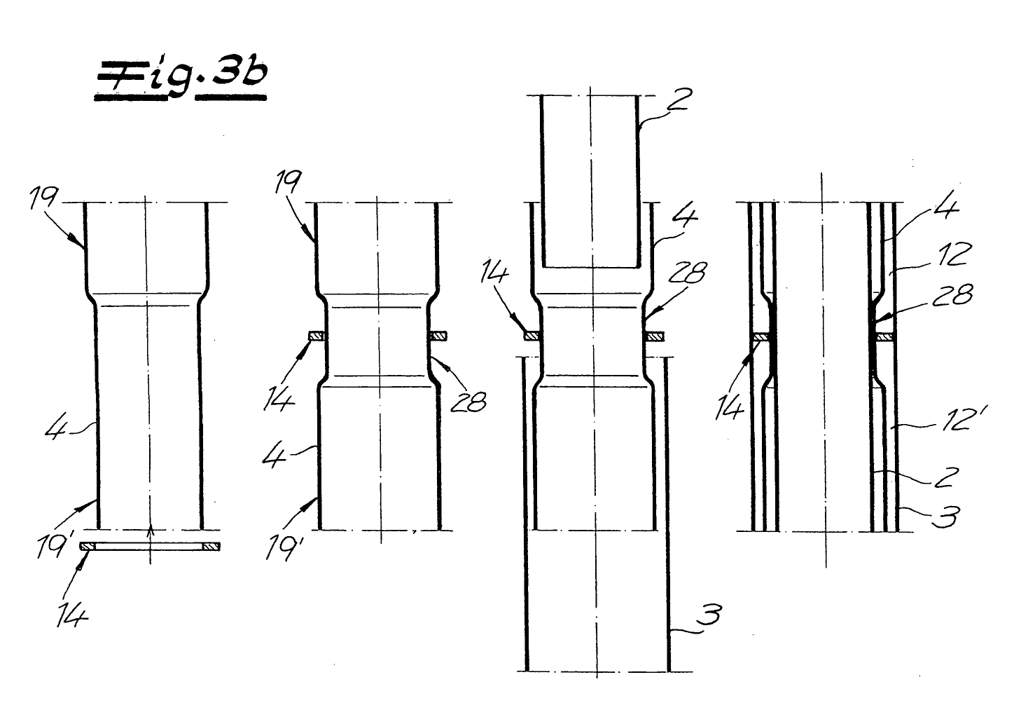

FIGS. 3a and 3b show highly schematic alternative methods for the production of a three-pipe system for a vibration damper 1. According to FIG. 3a, first a center pipe 4 is made available, in which passage openings 16 are first made in a center section 28. After constriction of a first end section 19 of center pipe 4, by means of a material deformation, a separation system 14 is pushed into center pipe 4, all the way to the center section 28, on the opposite side. Afterwards, the second end section 19′ is also constricted by means of a material deformation, whereby a groove 21 for an O-ring 20 is also produced on each end section 19, 19′. Subsequently, an outer pipe 3, in which passage openings 16′ have been made, is made available, whereby after that, the radially projecting center section 28 is pressed into outer pipe 3, with a press dimension of preferably 0.2 mm to 0.3 mm, in such a manner that passage openings 16 of the center pipe align with the passage bores 16′ of outer pipe 3. Furthermore, an inner pipe 2, which has bores 11 in the region of end sections 19, 19′ of center pipe 4, is pushed into the center pipe 4. In this connection, two flow spaces 12, 12′ form between center pipe 4 and inner pipe 2, which spaces are hydraulically sealed relative to one another by means of separation system 14.

FIG. 3b shows an alternative embodiment of the method, in which first, a first end section 19 of center pipe 4 is widened by means of a material deformation. Subsequently, a separation system 14 is pushed onto center pipe 4, all the way into the region of a center section 28, by way of the opposite second end section 19′. Subsequently, second end section 19′ is also widened, so that separation system 14 is disposed in center section 28 so as not to come loose. Finally, an inner pipe 2 is pressed into center section 28 of center pipe 4, which section springs back in the radial direction, with a press dimension of preferably 0.2 mm to 0.3 mm, in hydraulically sealed manner, and an outer pipe 3 is pushed onto center pipe 4, whereby flow spaces 12, 12′ are formed between outer pipe 3 and center pipe 4, which spaces are hydraulically separated by means of separation system 14. Separation systems 14 can be attached to center pipe 4 or to related inner pipe 2 or outer pipe 3, respectively, with snap rings 25, in each instance, whereby preferably, an insertion tool is used. In the case of the method according to FIG. 3b, passage openings 16, 16′ can also be made, after the coaxial placement of the pipes, as required.

Accordingly, although only a few embodiments of the present invention has been shown and described, it is apparent that many changes and modifications may be made thereunto without departing from the spirit and scope of the invention as defined in the appended claims.

What is claimed is:

1. A hydraulic vibration damper comprising:
(a) an inner pipe;
(b) an outer pipe surrounding the inner pipe, said outer pipe comprising an outer pipe passage opening;
(c) a center pipe disposed between the inner pipe and the outer pipe, said center pipe comprising a center pipe opening and a radially projecting formed-out part, the center pipe being connected with the outer pipe or the inner pipe at the radially projecting formed-out part in a hydraulically sealed manner via a press fit;
(d) a piston disposed on a piston rod;
(e) a valve module disposed on the outer pipe; and
(f) a separation system for hydraulic separation between the center pipe and the inner pipe or between the center pipe and the outer pipe;
wherein the inner pipe encloses a working space filled with hydraulic fluid, said working space being divided into first and second chambers by said piston;
wherein a first flow space lateral to the piston rod and a second flow space away from the piston rod are formed between the inner pipe and the center pipe;
wherein the first and second flow spaces are hydraulically separated from each other, each of said first and second flow spaces being connected with said valve module by way of said center pipe passage opening and said outer pipe passage opening respectively;
wherein the center pipe passage opening and the outer pipe passage opening are disposed near said formed-out part; and
wherein said separation system is set into said formed-out part between the first and second flow spaces.

2. The vibration damper according to claim 1, wherein the separation system comprises a seal ring disposed under tension between first and second disks, the disks being held on the center pipe or the inner pipe via a snap ring.

3. The vibration damper according to claim 1, wherein the separation system comprises a ring-shaped carrier having an inside and an outside, an inside seal ring being inserted on the inside and an outside seal ring being inserted on the outside, said ring-shaped carrier being held on the center pipe or the inner pipe with a snap ring.

4. The vibration damper according to claim 1, wherein the ring-shaped carrier is made of plastic or sintered metal.

5. The vibration damper according to claim 1, wherein the center pipe has a groove outside of the radially projecting formed-out part, wherein an O-ring is laid into said groove, and wherein the center pipe is connected with the inner pipe in a clamped manner by way of the O-ring.

6. The vibration damper according to claim 1, wherein the first chamber is lateral to the piston rod, the second chamber is away from the piston rod, the first flow space is hydraulically connected with the first chamber, and the second flow space is hydraulically connected with the second chamber.

7. A method for producing a three-pipe system for a vibration damper having a center pipe disposed between a first pipe and a second pipe comprising the steps of:
(a) subjecting each of a first end section and a second end section of the center pipe to a respective change in radius via material deformation;
(b) before deformation of the second end section, disposing a ring-shaped separation system having at least one elastic element on a center section of the center pipe between the first end section and the second end section in such a manner that after deformation of the first end section and the second end section, the separation system is held on the center section so as not to come loose;
(c) connecting the center pipe with the first pipe by way of the separation system in a hydraulically sealed and clamped manner; and
(d) connecting the center pipe with the second pipe by way of the center section via a press fit in a hydraulically sealed manner.

8. The method according to claim 7, wherein passage openings are made in the second pipe and in the center section of the center pipe, and wherein after the center pipe is connected with the second pipe, the passage openings of the center pipe align with the passage openings of the second pipe.

9. The method according to claim 7, wherein the separation system comprises a seal ring and first and second disks fixed in place on the center pipe or the first pipe under tension of the seal ring via snap rings.

10. The method according to claim 7, wherein the separation system comprises a ring-shaped carrier having an inside and an outside, an inside seal ring being inserted on the inside and an outside seal ring being inserted on the outside, and wherein the ring-shaped carrier is fixed in place on the center pipe or the first pipe with a snap ring.

11. The method according to claim 9, wherein at least one of the snap rings is inserted into an associated snap ring groove of the center pipe or the first pipe using an insertion tool.

12. The method according to claim 7, wherein each of the end sections of the center pipe is respectively constricted via a material deformation, wherein the center section projects with reference to the end sections and is pressed into the second pipe in hydraulically sealed manner, the second pipe forming an outer pipe of the three-pipe system, and wherein the separation system is disposed between the center pipe and the first pipe, which forms an inner pipe of the three-pipe system, in such a manner that hydraulically separated flow spaces are formed between the inner pipe and the center pipe.

13. The method according to claim 12, wherein the center section is pressed into the second pipe with a press dimension in a range of 0.2 mm to 0.3 mm.

14. The method according to claim 7, wherein each of the end sections of the center pipe is respectively radially widened via the material deformation, wherein the second pipe, which forms an inner pipe of the three-pipe system, is pressed into the center section of the center pipe in hydraulically sealed manner, the center section springing back in a radial direction, and wherein the separation system is disposed between the center pipe and the first pipe, which forms an outer pipe of the three-pipe system, in such a manner that hydraulically separated flow spaces are formed between the outer pipe and the center pipe.

15. The method according to claim 14, wherein the second pipe is pressed into the center section with a press dimension in a range of 0.2 mm to 0.3 mm.
